(19) United States
(12) Patent Application Publication
(10) Pub. No.: US 2018/0165688 A1
(43) Pub. Date: Jun. 14, 2018

(54) SOURCE-AGNOSTIC CORRELATION OF CONSUMER TELEPHONE NUMBERS AND USER IDENTIFIERS

(71) Applicant: Marchex, Inc., Seattle, WA (US)

(72) Inventors: Ziad Ismail, Seattle, WA (US); Clay Colburn, Mercer Island, WA (US); Adarsh Nair, Sammamish, WA (US); Sundi Raman, Redmond, WA (US); Jacob Lucas, Seattle, WA (US); Chris Zazzi, Seattle, WA (US); Preston Hillman, Seattle, WA (US)

(21) Appl. No.: 15/840,155

(22) Filed: Dec. 13, 2017

Related U.S. Application Data
(60) Provisional application No. 62/433,682, filed on Dec. 13, 2016.

(51) Int. Cl. G06Q 30/00; G06Q 30/02

(52) U.S. Cl. CPC G06Q 30/01; G06Q 30/0201; G06Q 30/0277

(57) ABSTRACT

A system and method that correlates a user identifier, associated with a computing device being used by a consumer, with a telephone number belonging to the consumer. The system maintains advertising impression data, describing online advertising impressions associated with user identifiers, and call data, describing telephone calls to a businesses and the telephone numbers from which the calls were received. Based on the maintained advertising impression and call data, the system generates correlations between telephone numbers and user identifiers for a consumer.

### CROSS-REFERENCE TO RELATED APPLICATION(S)

This application claims the benefit of U.S. Provisional Patent Application No. 62/433,682, filed on Dec. 13, 2016 and entitled “SOURCE-AGNOSTIC CORRELATION OF CONSUMER TELEPHONE NUMBERS AND USER IDENTIFIERS,” which is incorporated herein by reference in its entirety.

### BACKGROUND

Businesses interact with customers and prospective customers using a variety of communication channels, such as via wired or wireless telephone networks, the Internet, and in-person at brick-and-mortar stores. Although each communication channel can be somewhat successful by itself in engaging with any particular customer, businesses may prefer to utilize multiple communication channels to maintain customer engagements. For example, if a potential customer is using a telephone system to inquire about a product or service of the business, the business may desire to re-engage with the customer through another communication channel, such as with an Internet advertisement. One of the challenges faced by businesses, however, is in reaching a customer through one communication channel after an engagement through another communication channel. That is, a business may not know how to target a customer with Internet advertising following a telephone call from the customer.

Thus, there is a need for a system and method that enables businesses to re-engage with customers through multiple communication channels.

### BRIEF DESCRIPTION OF THE DRAWINGS

FIG. 1 is a block diagram of a system for cross-advertisement correlation of consumer telephone numbers and user identifiers.

FIG. 2 is an exemplary data structure of identity and advertisement impression data detected by the correlation system.

FIG. 3 is an exemplary data structure of interaction data provided by businesses to the correlation system.

FIG. 4 is an exemplary data structure maintained in an aggregated correlation database by the correlation system.

FIGS. 5A and 5B are flow diagrams illustrating a process implemented by the correlation system for associating a consumer telephone number with a user identifier.

FIG. 6 is a flow diagram illustrating a process implemented by the correlation system to target advertisements to a user.

FIG. 7 is a flow diagram illustrating a process implemented by the correlation system for determining the effectiveness of an advertisement or advertising campaign for physical storefronts.

### DETAILED DESCRIPTION

A method and system that correlates consumer telephone numbers with user identifiers based on relationships, identified across a plurality of businesses and consumer exposures to the plurality of businesses, is disclosed herein. The correlation system correlates user identifiers representing online activities of consumers with telephone numbers associated with each consumer, and stores the correlated pairs in an aggregated correlation database. The correlation database is advertising campaign, publisher, and business agnostic, meaning that the correlation database is not associated with any particular advertising campaign, publisher, or business. User identifiers (e.g., a cookie, a device or subscriber identifier, a user ID) are assigned by the system to track the online behavior of a consumer. The system uses the user identifier to track instances of the consumer's exposures to different businesses, such as when the consumer views the landing website page of a business, when the consumer activates a click-to-call hyperlink that initiates an online communication with a business, or when an online advertisement for a business is displayed to the consumer on the business's or third-party publisher's website. The user identifier is common across any business or publisher, such that the same user identifier will be associated with the same consumer for different exposures to different businesses. Telephone numbers are also provided to the correlation system, and are provided by businesses in connection with consumer calls to the business. As will be described in additional detail herein, advertisers, publishers and businesses may use the aggregated correlation database to, for example, effectively engage with a consumer.

When the correlation system detects occurrences in which a consumer having a user identifier is exposed to business information, such as the viewing of advertisements displayed on publisher websites, followed by calls from a consumer telephone number to the business, the system may correlate the telephone number with the user identifier. Whether the system correlates the consumer telephone number with the user identifier may be based on the proximity in time between the two events, the frequency with which the two events occur in proximity to each other, and other relevant information, such as whether the exposure event and telephone call event are in geographic proximity. The system forms correlations based on detected occurrences across multiple exposures and businesses. That is, data from different publishers and businesses is used in aggregate to form correlations, which enables the system to form more accurate correlations. For example, a user identifier-telephone number pair detected in connection with multiple occurrences of advertisements displayed to the user identifier and calls from the telephone number to different businesses associated with those advertisements is more likely to be an accurate correlation than a user identifier-telephone number pair detected only once.

Because of the inherent uncertainty in drawing correlations between user identifiers and consumer telephone numbers, the aggregated correlation database may include a confidence level associated with the correlated value pairs (user ID and consumer telephone number). The confidence level represents the likelihood that a particular telephone number is correlated with a particular user identifier.

Because the correlation system generates correlations based on data aggregated from different businesses, publishers, and exposures, the system is able to form correlations that are source-agnostic. That is, once a correlation is generated and saved in the correlation database, no indication is maintained by the database of the publishers or businesses from which the correlation was generated. Since the correlation database is anonymous with respect to the publisher and business data used to generate it, publishers and businesses are more willing to share their data with the correlation system, which further improves the ability of the system to generate correlations. Publishers and businesses further benefit from the agnostic nature of the correlation database since entries in the correlation database are valid for all users of the system, regardless of whether a publisher or business had previously reported an interaction with the user identifier or consumer telephone number. Additionally, because the correlation system is able to generate correlations based on regular occurrences of business exposures followed by telephone calls, publishers and businesses do not need to take special actions to determine correlations. For example, the correlation system can generate correlations without the use of telephone tracking numbers (“TTN”), such as was described in U.S. application Ser. No. 13/865,866 entitled CORRELATED CONSUMER TELEPHONE NUMBERS AND USER IDENTIFIERS FOR ADVERTISING RETARGETING.

The correlation system may be used by businesses to target advertisements to consumers. Businesses continually receive telephone calls from potential customers that do not result in a potential sale. For example, callers may call a business to ask questions about a product or seek details about a business (e.g., hours of operation, directions to the business). When a business receives calls from an individual, they are often able to identify the caller from caller ID. In order to target advertisements to those customers that have failed to convert as a result of the telephone call, businesses may provide the caller's telephone number and a desired advertisement or advertising campaign to the system. Using the aggregated correlation database, the system identifies the user identifier or identifiers that are associated with the telephone number. The system uses the identified user identifiers to target the advertisement or advertising campaign to the consumer. The system thereby allows contacts to a business that are received on one channel (e.g., the telephone) to be re-engaged by targeted advertising in a second channel (e.g., via a browser application that receives advertisements over a network).

In some embodiments, identified correlations between a telephone number and user identifier are not stored in the correlation database unless the corresponding confidence level, representing the likelihood of correspondence, exceeds a threshold value. In further embodiments, the stored confidence level is used by the system to control the use of the correlation system in customer targeting. A business may set a confidence threshold that they would like to have exceeded before targeting using the correlation database occurs. The confidence threshold value may be specified by the business in order to control how broadly or narrowly a targeting campaign based on cross-advertisement correlations is to be focused. If a stored confidence level does meet the threshold, a business in the alternative may employ traditional techniques, such as telephone tracking numbers, to determine a correlation between a customer telephone number and a user identifier. By first employing the correlation system, businesses can thus reduce their use of telephone tracking numbers.

The correlation system may also be used by businesses to evaluate the effectiveness of different advertisements. When a business makes a sale to a consumer, such as in a store, at a website, or over the phone, the business may capture the telephone number of the consumer to whom the sale was made. The business may use the telephone numbers associated with a set of sales, such as sales associated with a particular geographical region, to evaluate the advertisements displayed in that region. Using the aggregated correlation database, the system identifies user identifiers correlated to the telephone numbers from the set of sales data provided by the business. Using the identified user identifiers, the system determines which advertisements or advertising campaigns associated with the business were displayed to the consumers to whom sales were made. Based on the total number of impressions of those advertisements or advertising campaigns within the region, the system may then generate a performance metric for each of the advertisements (i.e., the percentage of impressions of an advertisement that resulted in a sale). By comparing the performance metrics for different advertisements, the system can evaluate the relative uplift of one advertisement or campaign with respect to another.

The system may generate correlations using anonymized telephone identifiers instead of actual telephone numbers. That is, when a business receives a call from a telephone number, it may generate an anonymous telephone identifier based on the telephone number and provide the telephone identifier to the correlation system. Telephone identifiers may be generated, for example, using a hash function or other transformation. The telephone identifiers may be generated in a manner prescribed by the system such that calls to different businesses from the same telephone number result in the same telephone identifier. The system then forms correlations between user identifiers and telephone identifiers and stores the correlations in the aggregated correlation database. Accordingly, no actual telephone numbers would be maintained by the correlation system. For purposes of the following description, a “telephone number” refers to either an actual telephone number or an anonymized telephone identifier.

Though primarily described with reference to user identifiers associated with online advertising impressions delivered by a publisher and telephone numbers obtained from calls to a business, user identifiers and telephone numbers obtained in different ways may be used. That is, the correlation system may generate correlations for user identifiers associated with different types of exposures to businesses as well as for user identifiers associated with advertising impressions across different mediums. For example, user identifiers may be used that are associated with users being displayed a webpage for a business, activating a click-to-call hyperlink that initiates an online communication with a business, or other online exposure events to the business may be used. As a further example, a user identifier associated with a television advertisement (e.g., a set-top box identifier), emailed advertisement (e.g., an email address), or other electronic communication may be used by the correlation system. Additionally, the correlation system may generate correlations based on telephone numbers obtained from different types of customer engagements. For example, a user telephone number may be obtained in connection with an in-store customer visit, a customer order that includes the customer telephone number, an electronic message containing a user telephone number in the body or in a footer (e.g., SMS, email, or messaging applications), or other customer engagement from which a business may obtain the customer telephone number. It will be appreciated that the correlation system may utilize user identifiers associated with business exposures of different types and across any advertising medium, and any type of customer engagement with a business, to form correlations.

Various embodiments of the invention will now be described with specific reference to the Figures. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

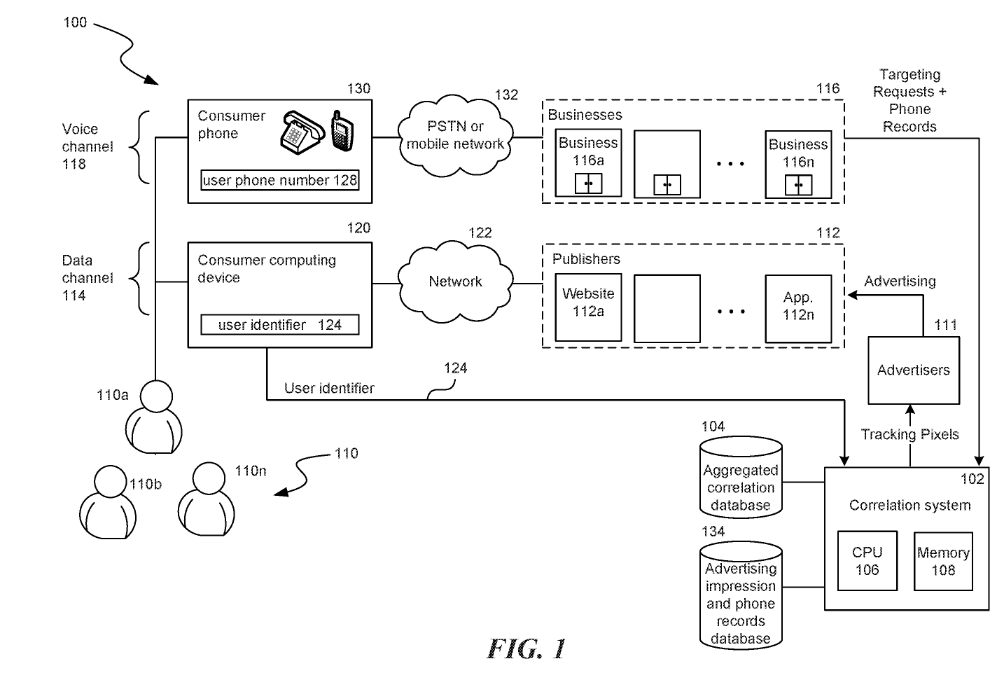

FIG. 1 is a block diagram illustrating a representative environment 100 in which a correlation system 102 may operate. The system 102 generates correlations between a telephone number of a consumer and a user identifier associated with network activities of that consumer, and stores the correlations in an aggregated correlation database 104. The correlation between telephone number and user identifier is used by the system to target advertisements to the consumer. The correlation between telephone number and user identifier is also used by the system to evaluate the effectiveness of advertisements based on sales data associated with consumers. The system 102 operates on one or more computing devices, such as server computers which may be configured in whole or in part as a web service. The system 102 utilizes one or more processors 106 (“CPU”) to execute instructions that perform various actions and implement decision logic. The computer executable instructions are stored in volatile or non-volatile memory 108 along with other data.

Those skilled in the art will appreciate that the system 102 may be implemented on any computing system or device. Suitable computing systems or devices include personal computers, server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

FIG. 1 and the following description describes an embodiment in which user identifiers used by the correlation system 102 are associated with advertising impressions viewed on publisher websites. However, as described herein, user identifiers may also be associated with other exposures of consumers to businesses that do not involve advertisements or publishers. For example, a user identifier used by the correlation system may be associated with a consumer visiting a webpage such as a landing page for a website associated with a business. Referring to FIG. 1, the system 102 receives data associated with two types of interactions involving consumers 110. The first type of interaction is between consumers 110 and publishers 112 over a data channel 114. A publisher is a party that publishes advertisements to a consumer's network-connected computing device via, for example, a website or an application. The second type of interaction is between consumers 110 and businesses 116 over a voice channel 118. The data associated with the two types of interactions, which comprises records of the interactions between the consumers and publishers or businesses, is maintained in an advertising impression and phone records database 134, and used in combination to populate the aggregated correlation database 104. The records of interactions between consumers and businesses may also be used by the system to identify potential customers on which to perform targeted advertising on behalf of a business and to evaluate advertisement effectiveness. Each type of interaction will be described in turn.

In the first type of interaction, a consumer 110 uses a computing device 120 having a web browser or other application to interact with a publisher website 112a or a publisher application 112n (e.g., an application installed on a mobile device). A publisher may have no affiliation with the advertised products or services. For example, the publisher may operate their own advertising network though which it receives advertisements (e.g., GOOGLE, YAHOO!, FACEBOOK) or the publisher may operate a content platform and receive advertisements from advertising networks (e.g., the NEW YORK TIMES, THE ONION). A publisher may also have a direct affiliation with the advertised products or services. For example, a publisher like KELLOGG'S or PROCTER AND GAMBLE may operate its own websites or applications to directly provide information about its products and services to consumers. The computing device may be a personal computer, laptop computer, notebook computer, tablet computer, smartphone, portable media player, gaming device, or other computing device that allows a consumer to access websites or applications. The computing device 120 relies upon a network 122 such as the Internet to connect to publisher websites or applications. Network 122 may be any private or public, wired or wireless, network. The publisher website 112a is hosted on one or more web servers that serve content to the consumer. The consumer's computing device 120 fetches, displays, and interacts with the web server via HTTP or other supported communication protocol.

To allow the consumer's online activity to be tracked, the correlation system 102 coordinates with advertisers 111 or with publishers 112 to insert a web beacon such as a tracking pixel into content that is delivered to the consumer's computing device. A tracking pixel is a pixel that, once displayed to a consumer, causes a unique user identifier 124 associated with the consumer to be transmitted to the system 102. The tracking pixel may be embedded in a displayed advertisement. The tracking pixel may also be embedded in the publisher homepage or other landing page. The tracking pixel also causes an identifier associated with the content that is displayed to the consumer, such as an advertising campaign identifier of which the displayed advertisement is a part, to be transmitted to the system 102. The identifier may be, for example, a unique identifier associated with the advertisement or advertising campaign, a telephone number of the business associated with the advertisement, or some other identifier that can be correlated with the exposure event. The tracking pixel also enables the correlation system to determine additional information, such as the time and date of the online activity, the type of web browser that was used, and the existence of cookies previously set by the system. The tracking pixel might be inserted, for example, into an advertisement that is presented to a consumer. Alternatively or additionally, the tracking pixel might be inserted into a landing page that a consumer is redirected to if they click on or otherwise select a displayed advertisement. While a tracking pixel is described herein, it will be appreciated that any object which allows the correlation system to unobtrusively determine whether a user has accessed content may be used. Such web beacon objects include, for example, JavaScript tags or clear gifs.

The system uses the unique user identifier 124 to track activities of the consumer each time an Internet domain is accessed. The unique user identifier 124 may be a cookie associated with a browser, a unique device identifier such as an International Mobile Station Equipment Identity (IMEI) number, an International Mobile Subscriber Identifier (IMSI), or other identifier that may be placed on the computing device or read by the system. For example, the first time that a consumer 110a visits a website, the correlation system 102 places a cookie on the consumer's computer or mobile device reflecting the website session. The user identifier 124 is common across different publishers 112, such that the same user 110 and/or computing device 120 will be associated with the same user identifier regardless of the websites 112a or applications 112n of different publishers that are accessed by the user. The system 102 maintains in the advertising impression and phone records database 134 a record of the consumer's exposure to any advertisements, advertising campaigns, or content that has an associated tracking pixel and that was served by the publisher to the consumer's computing device. If the consumer 110 returns to a publisher's website, additional advertisements may be associated with the consumer by virtue of the stored cookie or other unique user identifier.

On a continuous or periodic basis, the correlation system 102 analyzes the impression data that it receives as a result of monitoring consumer interaction with publisher websites 112a or publisher applications 112n. The actual value of the user identifier 124 may be the cookie, IMEI, IMSI, media access control address (MAC address), hardware/software fingerprint, etc., of the consumer's computing device. It will be appreciated that the correlation system 102 may be operated by a third party that is distinct from the publishers, or it may be operated by a publisher itself.

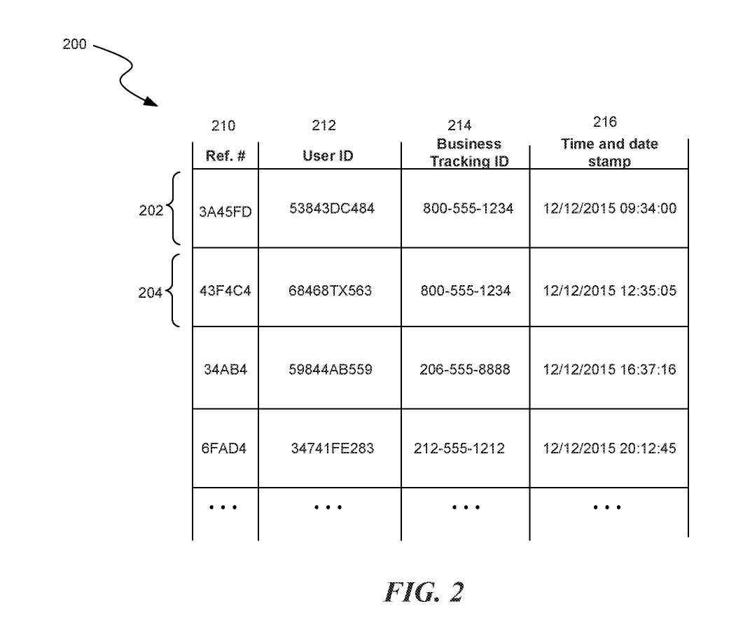

FIG. 2 is an example of a representative data table 200 maintained in the advertising impression and phone records database 134, which contains user identifiers and advertisement impression information that is received by the system 102. An advertiser identifier (not shown) is used to identify the corresponding advertiser 111 with which the received data is associated. The data in the table 200 is used by the system to correlate the provided user identifiers with consumer telephone numbers provided by businesses. Each row in the table 200 represents identity and impression information that is generated as a result of an interaction of a consumer with the publisher via data channel 114. For example, a row in the table 200 is generated when an advertisement on a publisher website or on a landing page of an advertiser was displayed to the consumer. Each column in the table 200 represents different data fields that characterize the interaction.

The first field of the data table 200 is a reference number field 210 that contains a unique identifier that is assigned to the advertiser 111 when the corresponding tracking pixels are distributed to that advertiser. The reference number is assigned by the correlation system 102 to facilitate data acquisition and tracking.

The second field of the data table 200 is a user identifier field 212. The user identifier field 212 is populated with a unique identifier associated with the consumer's device that interacted with the advertising content. For example, the user identifier may be based on a cookie that is associated with the consumer's browser. As another example, the user identifier may be based on the IMEI of the computing device that the consumer used at the time of the interaction. It will be appreciated that other unique identifiers including, but not limited to, a media access control address (MAC address) or hardware/software fingerprint may also be used by a publisher to identify the computing device used by the consumer. Notably, because the user identifier is assigned by the advertising system 102, the user identifier is common across all publishers with which the user and/or computing device interact. In the depicted example, row 202 includes the user identifier (e.g., “5843DC484”) received by the correlation system 102 as a result of the presentation of the tracking pixel.

The third field of the data table 200 is a business tracking identifier field 214. The business tracking identifier field 214 is populated with an identifier associated with the business, such as the advertised telephone number of the business. The business tracking identifier 214 is common among all publishers, such that the same advertisement displayed on different publisher websites will be associated with the same identifier. For example, when the business tracking identifier 214 is the telephone number of a business, all advertisements for the business may display the same business telephone number, regardless of which publisher or other webpage the advertisement appears on. Furthermore, the business telephone number used as a business tracking identifier may be the general-purpose telephone number of the business (i.e., the business's primary telephone number) instead of a special-purpose telephone number associated with a particular advertisement or advertising campaign (i.e., a telephone tracking number). As will be described in additional detail herein, the contents of the business tracking identifier field 214 may be used by the system to generate correlations between user identifiers and consumer telephone numbers. The contents of the business tracking identifier field 214 may also be used by the system to evaluate advertisement effectiveness.

The fourth field of the data table 200 is a time and date field 216. The time and date field 216 is populated by the correlation system 102 with a time and date stamp of when each consumer interaction occurred with the advertising content. As will be described in additional detail herein, the contents of the time and date field 216 may be used by the system to determine the proximity in time between a consumer interaction with the advertising content and a consumer telephone call to a business.

In some embodiments, the correlation system 102 may also receive information regarding the location of the consumer who viewed the advertising content. For example, the system might receive the location of the computing device on which the advertisement was displayed. The location could be based on, for example, GPS data, the IP address, or other techniques for geo-locating a mobile computing device. The location information could then be additionally saved in the table 200.

In some circumstances, the correlation system 102 may also receive information about which publisher the advertising content was presented on. In those circumstances, the system may maintain additional information (not shown), of the corresponding publisher information so that the system can track the source of the underlying data. For example, each entry in a table 200 might have an assigned publisher ID so that the system can associate each entry in the table with the publisher that displayed the corresponding advertising content.

It will be appreciated by one skilled in the art that relatively little information about the user's interaction with the advertising content is received by the correlation system 102. Other than a user identifier, a business tracking identifier, and a time and date stamp, no details of the consumer interaction need to be stored by the system.

Returning to FIG. 1, the correlation system 102 may also receive information associated with the interaction of consumers 110 with businesses 116 via the voice channel 118. To contact businesses 116, a consumer typically uses a telephone 130 that is owned or controlled by the consumer. For example, the telephone 130 may be the consumer's home phone, work phone, or mobile phone. In cases where the telephone 130 is the consumer's mobile phone, the mobile phone and the consumer's computing system 120 may be one and the same device. Consumer calls are made to a desired business 116 by dialing the phone number associated with that business. The dialed number allows the call to be routed through the public switched telephone network (“PSTN”) or mobile phone network 132 to the business. Consumer calls may be directly routed to the desired business, or terminated at a call center that manages calls for that business. In some embodiments, a business or a call center may have an interactive voice response (IVR) system to automate the interaction with consumers 110 and reduce the required staffing levels to answer calls.

When a consumer dials a business, the business and/or call center may determine the phone number 128 associated with the consumer's phone 130 using a caller identification (caller ID) service. With a caller ID service, the consumer's number is transmitted to the business's telephone equipment during the ringing signal, or when the call is being set up but before the call is answered. The detected telephone number is captured and stored by the business. A record of the interaction between the business and the consumer may be maintained by the call center or business, and continuously or periodically provided to the correlation system 102 where it is maintained in the advertising impression and phone records database 134. The interaction data may be transmitted to the system via an API, delivered via FTP, provided via storage media such as optical disk, etc.

Alternatively or additionally, consumer calls made to a desired business may be routed to the correlation system 102. Calls received by the correlation system may be handled by the system or may be forwarded to the desired business. That is, in one example, the system may manage consumer calls on behalf of the business. In a further example, the consumer call may have been made to a target tracking number (“TTN”) leased to the business from the system. When a call is routed to the correlation system, information about the call described herein may be determined directly by the system.

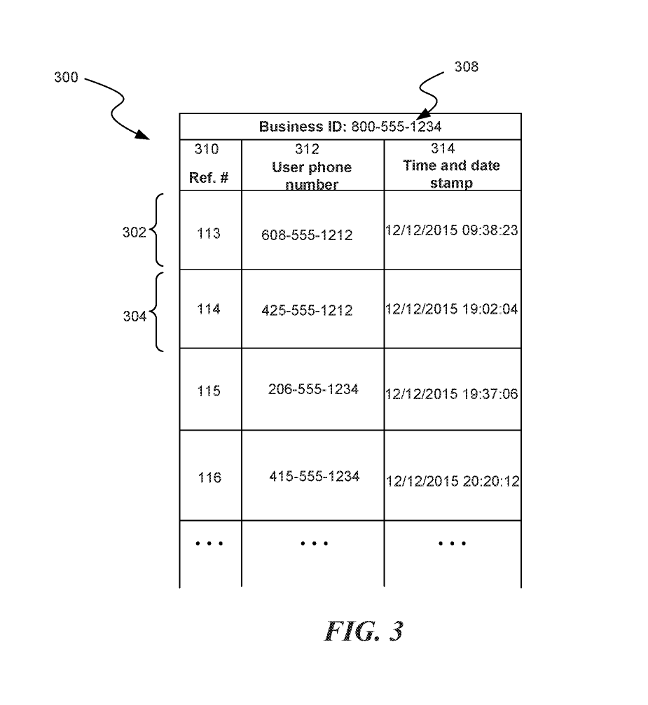

FIG. 3 is an example of a representative data table 300 maintained in the advertising impression and phone records database 134, which contains interaction data that is provided by a business 116, or by a call center associated with a business, to the correlation system 102. The data table 300 may also be directly constructed by the correlation system 102 as a result of receiving or routing calls for the business. The data in the table 300 is used by the system to correlate provided consumer telephone numbers with user identifiers provided by businesses. The data in the table 300 may also be used as part of a request to re-target consumers for advertising. Each table 300 includes a business identifier header 308, which indicates the business 116 associated with the interaction data. The business may be indicated, for example, using the general-purpose telephone number used to call the business. Each row in the table 300 represents an interaction of a consumer with the business 116 via the voice channel 118. Each column in the table 300 represents a different data field that characterizes the interaction.

The first field of the data table 300 is a reference number field 310 that contains a unique identifier that is assigned by or on behalf of the business 116 to the interaction record. The reference number may be assigned by or on behalf of the business for purposes of internal tracking of the interaction with the consumer.

The second field of the data table 300 is a user phone number field 312 that contains a telephone number (e.g., “608-255-1212”) of the consumer. As noted above, the phone number of the consumer may be automatically captured by the business, call center, or by the system using caller ID. Alternatively, the consumer may voluntarily provide their telephone number to the business representative that assists them, or provide their telephone number to an IVR system that handles the call.

The third field of the data table 300 is a time and date field 314, which is populated with a time and date stamp of when the consumer interaction occurred. As will be described in additional detail herein, the contents of the time and date field 314 may be used by the system to determine the proximity in time between the consumer telephone call to the business and a consumer interaction with a publisher.

In some embodiments, the correlation system 102 may also receive information regarding the location of the consumer who called the business. The location could be based on, for example, the telephone number from which the consumer called the business, using techniques for geo-locating a caller. The location information could then be additionally saved in the table 300.

The data in table 300 is associated with a single business that receives calls from consumers. As such, the data will typically be associated with a single telephone number that is associated with that business. In some circumstances, a call center may be responsible for receiving calls for multiple businesses. In such a scenario, the call center may use a dialed number identification system (“DNIS”) to determine which one of the multiple businesses it provides services for is being called. Such information is captured by the call center and used to populate the business identification header 308. By doing so, the system 102 is able to form an association between the user's telephone number and the business that is being called.

While the table 300 has been characterized as containing information received from only a single business, it will be appreciated that the system 102 will typically receive information from multiple businesses. In those circumstances, the system may maintain multiple tables 300, each of which is associated with a corresponding business identifier 308 so that the system can track the source of the underlying data. Alternatively, each entry in a table 300 may have an assigned business identifier so that the system can associate each entry in the table with the corresponding business from which it was received.

It will be appreciated by one skilled in the art that businesses 116 share relatively little information with the correlation system 102. Other than a user phone number and a time and date stamp, no details of the consumer interaction need to be shared with the system.

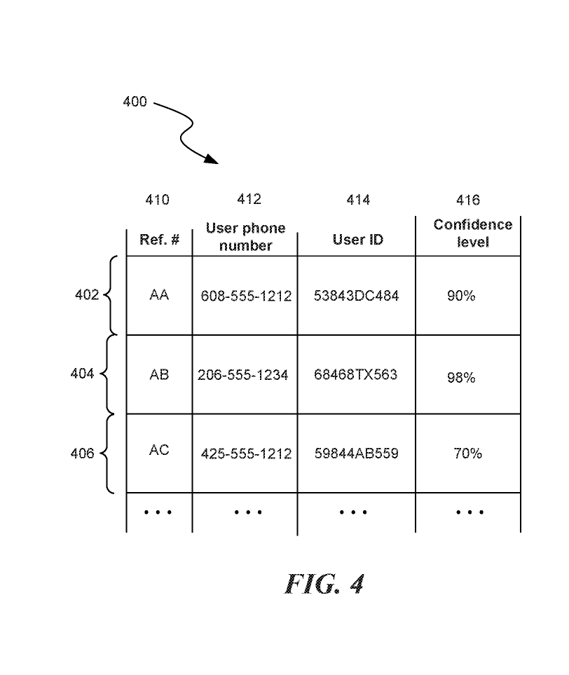

Returning to FIG. 1, the correlation system 102 uses the information that it receives from publishers 112 and businesses 116, or that it receives directly, to populate the aggregated correlation database 104. FIG. 4 is an example of a representative data table 400 containing correlation information generated by the correlation system 102 and stored in the aggregated correlation database 104. The table 400 maintains a correlation between a user identifier that was generated by the system and a telephone number associated with a consumer. In addition, a confidence level may be stored for each stored pair (i.e., telephone number and user identifier). The confidence level reflects the system's confidence that the user identifier and the corresponding telephone number are associated with the same consumer.

Each row in the table 400 represents an entry correlating a user telephone number with a user identifier. The first field of the table 400 is a reference number field 410 that contains a unique identifier that is assigned by the system 102 to the correlation entry. The reference number may be assigned by the system for purposes of internal tracking. The second field of the table 400 is a user phone number field 412 that contains a phone number of a consumer. The third field is a user identifier field 414 that is populated with the user identifier correlated with the corresponding telephone number. The fourth field is a confidence level field 416, reflecting a confidence of the system that the user identifier and the telephone number are indeed associated with the same consumer. A confidence level of 100% indicates that the system 102 has confirmed that the user identifier and telephone number are associated with the same consumer. A confidence level above 50% indicates that the system believes that the user identifier and telephone number are more likely than not associated with the same consumer, whereas a confidence level below 50% indicates that the system believes that the user identifier and telephone number are likely not associated with the same consumer. As will be described in additional detail herein, each entry in the table 400 reflects a correlation based on data from a plurality of businesses and publishers used in aggregate. As a result the correlation entry could potentially be used by any publisher or business with access to the system.

The correlation system 102 populates the table 400 using the data received from publishers 112, businesses 116, or detected by the correlation system itself. For example, row 402 of the table reflects that the system has 90% confidence that the user identified by the user identifier “53843DC848” is associated with the phone number “608-555-1212.” Such information and confidence level is derived from row 202 of table 200 and row 302 of table 300. In the interaction represented by row 202, a user associated with the user identifier “53843DC848” viewed an advertisement displaying the telephone number “800-555-1234” at 9:34 AM on the indicated day. In the interaction represented by row 302, a consumer dialed the business associated with the business identifier “800-555-1234,” corresponding to the business's telephone number, from the telephone number “608-555-1212” at 9:38 AM on the same day. Because the system is able to determine that a user viewed an advertisement associated with a business, and shortly thereafter the business received a telephone call, the system generates a correlation between the user identifier associated with the user and the telephone number from which the call was made. The confidence of the correlation may depend on the nearness in time of the two events. The confidence of the correlation may also depend on the call volume received by the business (i.e., if a business receives few calls then a confidence associated with a correlation may be higher than for a business that receives relatively more calls). A simple equation for calculating the confidence factor is: C=(Δₘᵢₙ*0.1))*V, where C represents the confidence in a correlation between an observed user identifier and telephone number, Δₘᵢₙ represents the difference in minutes between when the user identifier viewed an advertisement and when a call was received from the telephone number, and V represents an adjustment factor associated with the volume of calls received at the business. In the representative equation, a call received within one minute of an advertising view yields a correlation confidence of 0.9 (i.e., 90%) before adjustment due to call volume, while a call received within nine minutes of an advertising view yields a correlation confidence of 0.1 (i.e., 10%) before adjustment due to call volume. Other factors may be used for calculating a confidence factor. For example, if location information associated with the advertising interaction (e.g., the location of the computing device on which the advertisement was displayed) falls within a threshold distance of a location of the business contacted by consumer, then the confidence of correlation may be increased. It will be appreciated by one skilled in the art that other equations for calculating a confidence factor based on the nearness in time of the two events, the volume of calls received by the business, and other factors, may be used.

Though in the illustration above the correlation entry 402 was generated based on a single interaction with a publisher (i.e., row 202) and business (i.e., row 302), the correlation entry could be based on multiple publisher and business interactions. For example, a business may have received multiple calls from the same telephone number, and the system may detect that each of those calls occurred soon after advertisements associated with the business were displayed to the same user identifier. Each subsequent call would increase the confidence factor (e.g., by a fixed increment such as 10%, or by an increment proportional to the proximity in time of the call), as the likelihood that the display of an advertisement and a subsequent call are not directly related decreases. As a further example, the correlation may be generated based on data from different publishers and businesses, such as when multiple businesses receive a telephone call from the same telephone number, and the system detects that each call to each business occurred soon after advertisements associated with the businesses were displayed to the same user identifier. That is, if there are multiple occurrences of an interaction associated with a user identifier followed by a telephone call from a consumer telephone number, then the confidence of correlation between the user identifier and the consumer telephone number may be increased.

While FIGS. 2-4 depict tables whose contents and organization are designed to make them more comprehensible by a human reader, those skilled in the art will appreciate that the actual data structure(s) used by the facility to store this information may differ from the tables shown, in that they, for example, may be organized in a different manner, may contain more or less information than shown, may be compressed and/or encrypted, and may be optimized in a variety of ways.

### Generating Correlations for an Aggregated Correlation Database

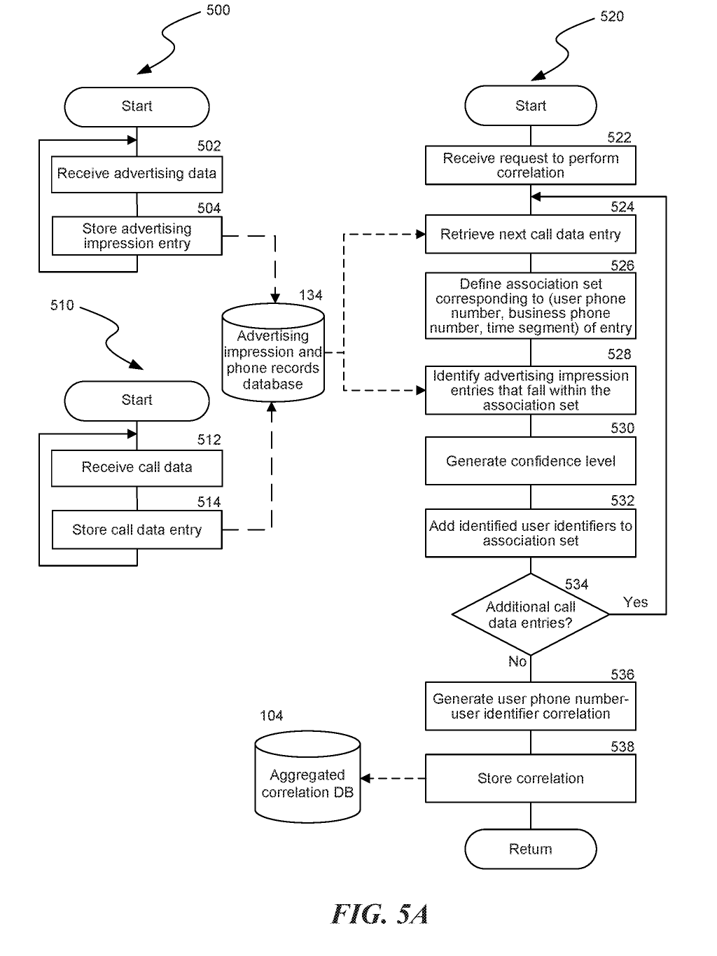

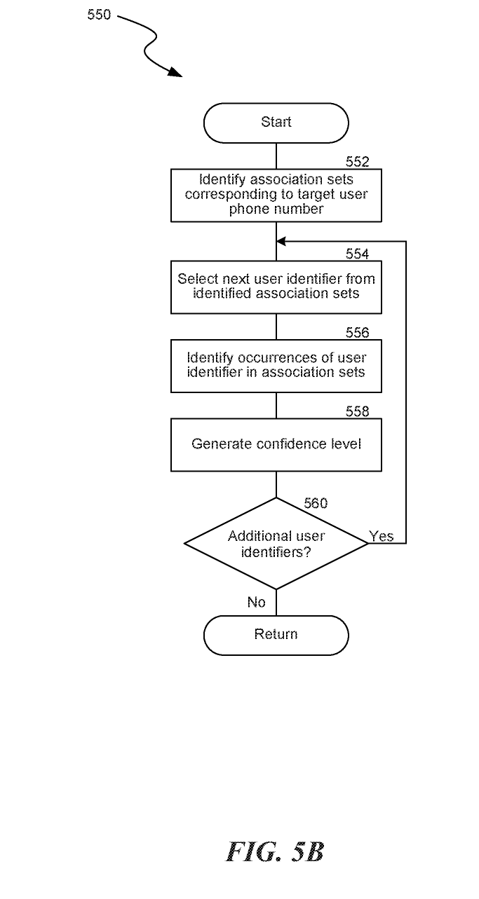

FIGS. 5A and 5B are flow diagrams illustrating processes 500, 510, 520, and 550 implemented by the correlation system 102 for storing advertising impressions associated with user identifiers and consumer calls associated with consumer telephone numbers, and for generating correlations of the stored user identifiers with the stored consumer telephone numbers. The processes 500, 510, 520, or 550 are performed in part or in full by the correlation system 102. Some or all steps may be executed by the processor 106, and stored as computer executable instructions in the memory 108.

Process 500 causes advertising impression information to be captured by the system. Referring to FIG. 5A, the process 500 begins at a block 502, in which the correlation system 102 receives advertising data associated with an online advertisement viewed by a consumer. As described previously, advertising data may be received following a user viewing content into which a tracking pixel was inserted. The advertising data may include a unique user identifier and a business tracking identifier. At a block 504 an advertising impression entry based on the received data, for example as illustrated by table 200, is stored in the advertising impression and phone records database 134. Process 500 then returns to block 502 to receive additional advertising data.

Process 510 causes the system to acquire call data associated with businesses. The process 510 begins at a block 512, in which the correlation system 102 receives call data associated with a telephone call from a consumer to a business. The call data may include a consumer telephone number from which the call was received, a time and date of the call, and a business identifier. At a block 514, a call data entry based on the received data, for example as illustrated by table 300, is stored in the advertising impression and phone records database 134. Process 510 then returns to block 512 to receive additional call data.

Process 520 is performed by the correlation system 102 to construct or update the aggregated correlation database 104. The process 520 begins at a block 522, in which the correlation system 102 receives a request to generate correlations based on the stored advertising impression data and call data. For example, the request may be initiated by a business that wishes to correlate one or more consumer telephone numbers known to the business (e.g., telephone numbers derived from calls that were received by the business) to user identifiers. The target consumer telephone numbers for which the business wants correlations to be generated are included as part of the request. As a further example, correlations may be generated without receiving a request, such as on a continuous basis as the advertising impressions and phone records database is updated (e.g., from processes 500 and 510) or on a periodic basis.

Broadly characterized, the process 520 first generates, at blocks 524 through 534, association sets that capture user identifiers that may correlate to a consumer telephone number associated with a particular telephone call. Then at blocks 536 and 538, the process 520 analyzes the generated association sets to identify correlations.

At a block 524, the system retrieves the next call data entry from the advertising impression and phone records database 134. As described previously, each call data entry corresponds to a single telephone call to a business, and includes the consumer telephone number from which the call was received, the date and time of the call, and an identifier associated with the business that was called. The business identifier may be, for example, a telephone number at which the business can be reached. If the request to perform correlation included target consumer telephone numbers for which a business seeks correlations, then in some embodiments the system at block 524 will only retrieve call data entries corresponding to telephone calls from the target consumer telephone numbers. In those embodiments, it should be noted, the system will still retrieve call data entries corresponding to telephone calls to businesses other than the requesting business.

At a block 526, the system defines an association set based on the retrieved call data entry. The defined association set is characterized by the consumer telephone number and business identifier of the call data entry and a time segment based on the date and time of the call entry. The time segment represents a window of time, ending at the time of the call, of interest for that association set. The time segment may be a fixed-length duration. For example, the time segment may be set to capture the five minutes prior to the time of the call, the ten minutes prior to the time of the call, or other. The time segment may also be set according to a duration that varies based on the volume of calls received by a business. For example, the time segment for an association set corresponding to a call to a frequently-called business may be set to a duration of two minutes, while the time segment for an association set corresponding to a call to an infrequently-called business may be set to a duration of an hour. As described, each unique combination of consumer phone number, business identifier, and time segment from the maintained call data corresponds to a particular association set defined by the system.

At a block 528, the system identifies advertising impression entries from the advertising impression and phone records database 134 that fall within the defined association set. As described previously, each advertising impression entry includes a user identifier, a business tracking identifier, and a date and time of when the advertising impression occurs. An advertising impression entry falls within an association set if the business tracking identifier of the advertising impression entry is the same as the business identifier that characterizes the association set (i.e., a business phone displayed in an advertisement is the same as the phone number that was dialed in call corresponding to the association set), and if the timestamp of the advertising impression entry falls within the time segment characterizing the association set. Other factors may be used to identify advertising impression entries that satisfy the association set definition. For example, if location information of the advertising impression entry and the call are maintained by the system, the system may consider whether the two locations are within a threshold proximity to each other (e.g., in the same state, in the same city, in the same ZIP code, within a threshold distance).

At a block 530, the system generates confidence levels as between the association set and each of the matching advertising impression entries. These confidence levels reflect an initial assessment that the user identifier of an advertising impression entry and the consumer telephone number characterizing the association set are both associated with the same individual. The confidence level may be based on the proximity of time between the timestamp of the advertising impression entry and the end of the time segment of the association set (i.e., the time at which the call occurred). For example, if the timestamp and time segment show that the call occurred soon after the advertisement was displayed to the user (i.e., in close in proximity to the end of the time segment), then the generated confidence level may be higher than if the timestamp and time segment show that the two events occurred temporally further apart. That is, the amount of the generated confidence level may decrease as a function of increased time between the two events, and could additionally go negative. As a further example, if location information is maintained by the system, the generated confidence level could be greater for two events that are located physically closer to each other. The system may also generate negative confidence levels for certain advertising impression entries. For example, for advertising impression entries with a timestamp outside of the time segment (i.e., the advertising impression occurred too early relative to the call or occurred after the call), the system may generate a negative confidence level.

At a block 532, the user identifiers associated with each of the matching advertising impression entries is added to the association set. Each added user identifier is also associated with the confidence level generated for the corresponding advertising impression entry. In other words, the association set characterized by a consumer telephone number, business identifier, and time segment (from the call data) is populated with the user identifiers of certain matching advertising impression entries.

At a decision block 534, the system determines whether there any additional call data entries in the advertising and phone records database 134 for which an association set needs to be generated. As described herein, in some embodiments association sets are only generated for call data entries from consumer telephone numbers that match a target consumer telephone number (based on the received request). In some embodiments, association sets are generated for all call data entries from a certain timeframe (e.g., calls that were received by businesses in the past six months). In some embodiments, association sets are generated for all call data entries of the database. If there are additional call data entries for which an association set should be generated, processing returns to block 524 to generate the next association set. Otherwise, processing continues to a block 536.

At the block 536, the system generates a correlation entry between a consumer telephone number and a user identifier. The system may generate a correlation entry for a specific consumer telephone number, such as a target consumer telephone number provided as part of a correlation request. In some embodiments the system may generate correlation entries for all consumer telephone numbers found in the call data entries. The system may also generate multiple correlation entries for the consumer telephone number, each correlating to a different user identifier. A correlation entry is generated based on, for example, identified overlaps in the generated association sets. The operation of block 536 is described in greater detail in FIG. 5B.

FIG. 5B is a flow diagram illustrating a process 550 for generating a correlation entry for a target consumer telephone number. As described above, the process 550 may be initiated for a target consumer telephone number corresponding to a business's request to generate a correlation for that consumer telephone number. As another example, the process 550 may be initiated for each of the consumer telephone numbers in the call data.

At a block 552, the system identifies the association sets that correspond to the target consumer telephone number. As describe above, each association set is characterized by a consumer telephone number, a business identifier, and a time segment. The corresponding association sets are all the association sets for which the consumer telephone number matches the target consumer telephone number, regardless of the business identifier and time segment that characterize those association sets.

At a block 554, the system selects a user identifier present in any of the identified association sets. At a block 556, the system identifies the occurrences of the selected user identifier across the different identified association sets. That is, the system identifies the total number of times the selected user identifier appears in the identified association sets. In addition to determining the total number of identified association sets in which the user identifier appears, the system also determines the number of different businesses represented by the total number of occurrences (based on the business identifiers characterizing the different association sets), as well as the number of occurrences of the user identifier for a single business (based on instances of the user identifier being found in association sets characterized by the same business identifier but with different time segments). In this way, the system determines how frequently, and in what sort of distribution across businesses, the selected user identifier was matched to the target consumer telephone number (as a function of the identifier being found in the identified association sets).

At a block 558, the system generates a confidence level representing a likelihood that the selected user identifier and the target consumer telephone number are both associated with the same individual. The generated confidence level may be based on the total number and distribution of occurrences of the selected user identifier (determined at the block 556), as well as the previously-generated confidence levels associated with each occurrence of the user identifier in the identified set (generated at the block 536). For example, the system may take an average of the previously-generated individual confidence levels and adjust the average based on the total number and distribution of occurrence. That is, a user identifier that occurs in a large number of association sets characterizing different businesses may be adjusted to have a higher confidence level than a user identifier that occurs in only a small number of association sets all characterizing the same business. In some embodiments, the average of the previously-generated confidence levels of individual occurrences may be weighted, such that more recent events are more heavily weighted. In some embodiments, the previously-generated confidence levels of individual occurrences may be weighted based on the call volume of the business corresponding to the association set with which the individual confidence level is associated. That is, a confidence level added to an association set that corresponds to a business receiving few calls may be weighted more heavily than confidence levels added to an association set that corresponds to a business receiving many calls.

At a decision block 560, the system determines whether there are additional user identifiers founds in the identified association set. If there are, the process returns to block 554, and selects the next user identifier to identify its occurrences in the association set and to generate a confidence level. Otherwise the process 550 returns.

Returning to FIG. 5A, at a block 538 the system stores correlation entries for the consumer telephone number in the aggregated correlation database 104. A correlation entry is comprised of a consumer telephone number, a user identifier, and a confidence level that the consumer telephone number and user identifier are associated with the same individual. As described with respect to the process 550, the system may generate confidence levels that different user identifiers are correlated with the consumer telephone number. In some embodiments, the system stores the correlation entry for the correlation having the highest confidence level. In some embodiments, the system stores all correlation entries that have a confidence level above a threshold (such as, for example, 80%). The process 520 then returns.

On a periodic or continuous basis, the system 102 may audit the aggregated correlation database 104 and remove or modify entries in the database to maintain the currency of the database. Entries in the database may be removed or modified based on a variety of factors. For example, the system 102 may remove any telephone numbers that haven't been targeted within a certain period (e.g., 1 year, 18 months).

### Consumer Re-Targeting Using the Aggregated Correlation Database

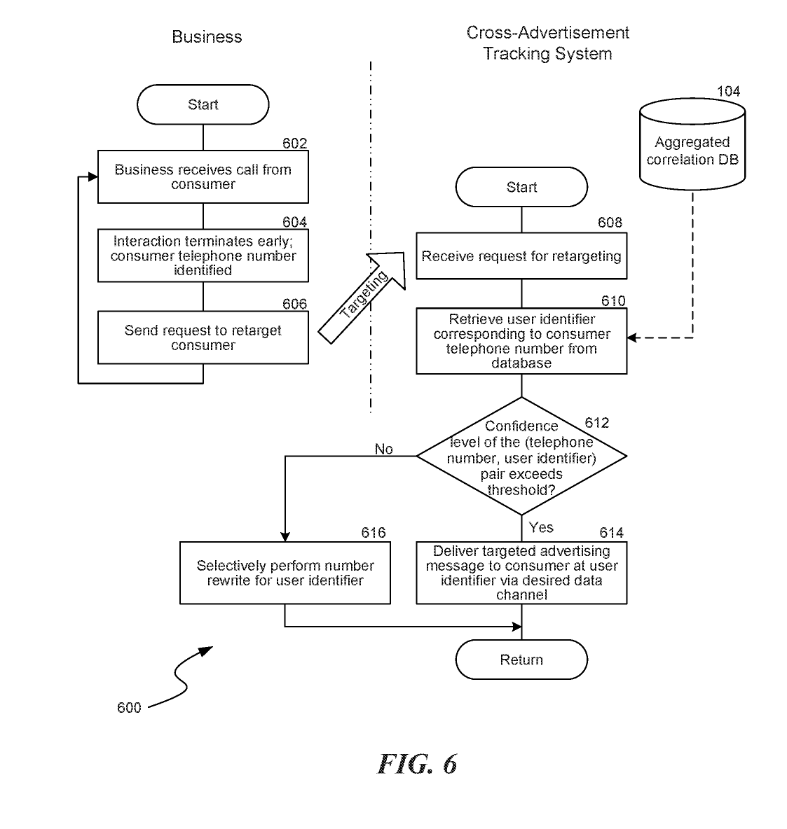

Once the aggregated correlation database 104 has been built by the correlation system 102, businesses and publishers may take advantage of the link between telephone numbers and user identifiers in order to better target consumers with advertisements. FIG. 6 is a flow diagram illustrating a process 600 implemented by the correlation system 102 for performing targeted advertisements of consumers. The process 600 is performed in part or in full by the correlation system 102. Some or all steps may be executed by the processor 106, and stored as computer executable instructions in the memory 108.

At a block 602, a business 116 receives a call from a consumer 110. For example, a consumer 110a may utilize phone 130 to dial the business number “1-800-NORTHCO.” As was previously described, a call center may utilize automatic number identification or caller ID to determine the consumer phone number 128. The call center can also determine the dialed number (e.g., “1-800-NORTHCO”). The business 116a may store information such as an ANI-determined consumer phone number (“206-555-0001”), the time of the call, the number dialed, and so on, in table 300.

At a block 604, the business 116 determines that the consumer phone call terminated early. For example, the consumer 110a may have started a business transaction with the NorthCo call center, but the call may have been dropped or the consumer may have decided to not complete the transaction. An operator at the call center may enter an indication of the failure to complete the phone transaction that gets stored in the table 300, or the IVR system may store a current IVR state at the time of the call drop in the table 300. Although not shown in table 300, additional details may be stored, such as at what point in an IVR session (e.g., during which menu and state) the call terminated. For example, while using an IVR system the consumer may have reached a menu option requesting the consumer to enter credit card information. If the consumer did not have a credit card readily available, the consumer may have hung up the phone. In such circumstances, it may be especially advantageous for NorthCo to “re-target” the consumer in order to try to get the consumer to perform the transaction to completion.

At block 606, the business 116 sends a re-targeting request to the correlation system 102. The re-targeting request includes the phone number of the consumer that is to be re-targeted. The re-targeting request may also include a desired publisher through which to re-target the consumer, and an indication of a particular advertising treatment or advertising campaign that is to be displayed to the targeted consumer. Depending on the relationship between the business and the correlation system, the request may also include an amount that the business is willing to pay for the targeted advertisement. The amount paid for the advertisement may be on a per-impression basis, on a per-click basis, on a per-call basis, or based on some other agreed financial arrangement as is common in the online advertising industry. The business then continues to receive calls from additional consumers at block 602. Although FIG. 6 depicts a targeting request being made immediately after a terminated consumer interaction, it will be appreciated that the targeting request may be made periodically (e.g., hourly, daily, weekly) and encompass an aggregate number of consumers that the business is interested in targeting based on interactions with the consumer during the preceding period.

At a block 608, the correlation system 102 receives the request to re-target a consumer. As noted, the request includes the consumer phone number and an indication of a desired advertisement. The request may also include other information that the business would like to provide to facilitate the targeted advertising. For example, the request may include a desired time of day, cap on number of times an advertisement should be presented to a consumer, or desired price to generate the call from the consumer. In addition, the request may include a preference about the publisher or type of publisher with which the business is willing to advertise. Businesses may have strong preferences for certain types of publishers over others. Some publishers may have desirable brands with which the business would like to be associated. Other publishers may have weaker brands or content that a business would like to avoid. Using a blacklist or a whitelist, a business may therefore specify which publishers the business would like to avoid and/or which publishers the business would like to target. The publisher may be identified by name (e.g., a request to publish with the “New York Times”), the publisher may be identified by type (e.g., a request not to publish with any alcohol beverage manufacturers), or the publisher may be identified by other keyword or criteria limitation. If not specified by a business, the system may select publishers that are likely to provide the highest likelihood of success for the desired advertisements.

At a block 610, the system uses the received telephone number as an index to the aggregated correlation database 104 to retrieve the correlation entry, including user identifier and confidence level, for the telephone number from the database. For example, the system may use the number “425-555-1212” to retrieve the corresponding user identifier “59844AB559” as shown in row 406 of table 400.

At a decision block 612, the system compares the retrieved confidence level of the correlation entry to a threshold desired confidence level. The desired confidence level may be configured by a system operator, may be determined by the business requesting the targeted advertisement, or may determine algorithmically to meet return on investment (ROI) goals of the advertising campaigns. For example, a business may specify that they do not want to target a consumer if the confidence that the user identifier is associated with the telephone number does not exceed 75%. If the confidence level does not exceed the desired threshold level at decision block 612, processing proceeds to block 616 where the system may flag the user identifier for telephone tracking number rewrite. If, however, the confidence level exceeds the threshold level at decision block 612, processing proceeds to a block 614.

At block 614, the correlation system 102 causes a re-targeting message to be transmitted to the consumer via data channel 114 and a selected publisher 112. The publisher may be selected based on publisher preferences received with the business request for re-targeting. The system may further verify, based on the advertising impression data, whether the consumer has previously interacted with the publisher designated by the business. For example, the system may request that the selected publisher display a desired targeted advertisement or advertising campaign to the consumer the next time the consumer uses a web browser to access a website of the publisher. The publisher identifies the consumer by the user identifier that is provided by the system 102, and uses the provided user identifier to serve advertisements to the desired consumer. A publisher 112 may notify the correlation system 102 when the requested advertising has been delivered to the desired consumer. If the requested advertising is not delivered to the desired consumer within a specified timeframe, the request by the system to have the advertisement be displayed by the publisher may lapse.

The delivered re-targeting message should ideally be tailored to encourage the consumer to complete the previously terminated engagement, or to otherwise reengage with the business. For example, the delivered advertising message may allow a consumer to bypass unnecessary menus that would otherwise make completing or reinitiating the transaction more cumbersome. For example, the consumer may be presented a special phone number for directly reaching a call center agent (e.g., bypassing the IVR) who can directly request the credit card information to complete the terminated transaction.

In some embodiments, the re-targeting message is further tailored based on other known information about the consumer. For example, the advertisement may be tailored based on past advertisements already displayed to the consumer, past purchases of the consumer, known likes or dislikes of a consumer, demographic information characterizing the consumer, etc.

In some embodiments, a business may be charged for an advertisement based on the confidence level associated with the targeted consumer. Advertisements that are targeted at user identifiers having a higher confidence level are charged more, and advertisements that are targeted at user identifiers having a lower confidence level are charged less. The differential charging is intended to compensate for the reduction in accuracy associated with targeting user identifiers having a lower confidence level.

In some embodiments, a publisher 112 will provide a user identifier to the correlation system 102 and solicit advertisements to present to the user identifier. In such a scenario, the correlation system 102 can determine whether any outstanding advertising requests remain to be targeted to the identified consumer. If advertising requests remain outstanding, the system responds to the publisher 112 with the desired advertising treatment for the consumer. In this fashion, the system may respond in an on-demand fashion in order to target consumers at the time that they visit a publisher website or application.

While the previously-provided example of re-targeting pertained to a consumer that had an interrupted transaction with a business, it will be appreciated that a business may opt to re-target consumers for a variety of reasons. For example, a business may desire to re-target a group of consumers that have recently purchased a particular product in the hope to upsell the consumers with warranty or extended service contracts, complementary products (e.g., cases, accessories, etc.), or other value-added product or service. As another example, businesses may wish to re-target consumers that they have recently lost. By offering a discount or other benefit to a consumer, the business may successfully convince the consumer to give the business a second chance. It will be appreciated that the disclosed technology allows businesses to target consumers for a variety of different reasons in a manner that is not very intrusive to the consumer.

In some embodiments, a business 116 may use the correlation system 102 to target existing or new consumers, regardless of any prior interaction that the business may have had with the consumers. For example, a business may have generated a list of consumers and corresponding telephone numbers of the consumers that they are trying to reach. The list may be constructed, using third-party databases which allow consumers to be identified and selected based on various consumer characteristics (e.g., geography, demographics). The business can provide a list of consumer telephone numbers to the system, which can then target advertisements to those consumers using the methodology described herein.

### Determining Advertisement Effectiveness Using the Aggregated Correlation Database

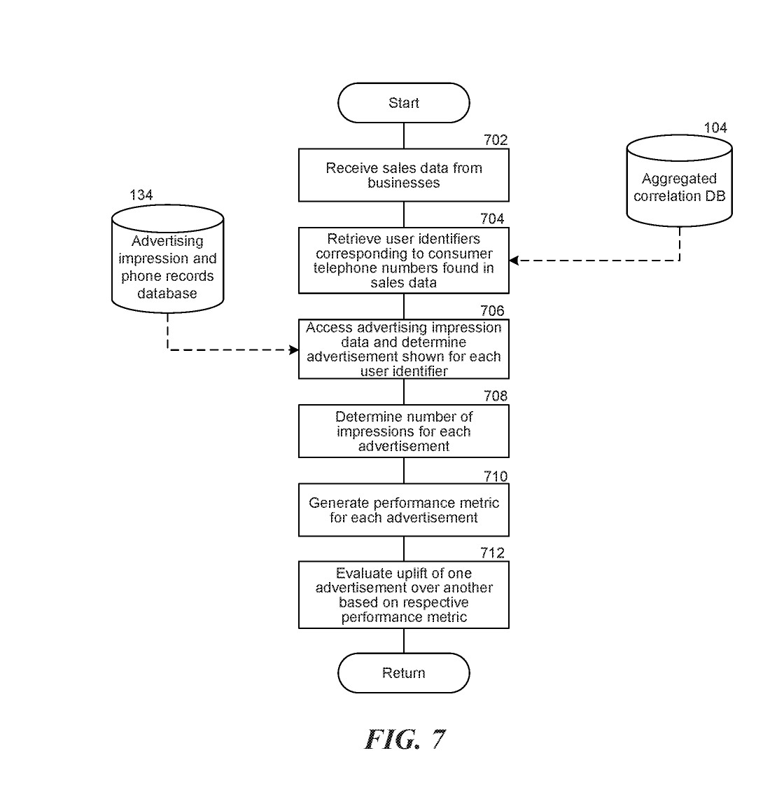

A business can measure the effectiveness of digital advertising (e.g., brand advertising) by using the aggregated correlation database in combination with business sales data. FIG. 7 is a flow diagram illustrating a process 700 implemented by the correlation system 102 for evaluating advertisement effectiveness. The process 700 is performed in part or in full by the correlation system 102. Some or all steps may be executed by the processor 106, and stored as computer-executable instructions in the memory 108.

At a block 702, the correlation system 102 receives sales data from a business 116. When a business makes a sale to a consumer, such as in a store, at a website, or over the phone, the business may capture the telephone number of the consumer to whom the sale was made. The business may send a set of sales data, such as sales associated with a particular geographical region, to the system for evaluating the effectiveness of advertisements displayed in that region.

At a block 704, the system retrieves from the aggregated correlation database 104 the user identifiers correlated to the telephone numbers in the received sales data. The system may filter out those correlation entries that have a confidence level less than a threshold confidence level set by a system operator or the business.

At a block 706, the system accesses the advertising impression data, such as illustrated by table 200, stored in the advertising impression and phone records database 134. The system identifies relevant advertisements by using the user identifiers retrieved from the aggregated correlation database 104. The system may additionally access information, such as in the advertising impression and phone records database 134, characterizing the type or content of the advertisement for each identified advertisement impression entry. For example, the system may access advertising campaign identifiers associated with each of the impressions. In combination with the received sales data, the system may also determine the total number of sales associated with each of the advertising campaigns. The system may further filter the advertising campaigns to those associated with the business in the geographical region of interest, based on, for example, a list of advertising campaign identifiers provided by the business.

At a block 708, the system determines the number of impressions for each advertising campaign identified in the previous step 706. For example, the system may calculate the number of impressions for a given advertisement based on the number of advertising impression data entries having that advertising campaign identifier. Alternatively, the publisher or business may already have impression counts and may provide it to the system. The system may further filter the impression counts to the advertising campaigns that were displayed to users within the geographical region of interest.

At a block 710, the system generates a performance metric for each of the identified advertising campaigns. For example, the system may use the number of sales associated with an advertising campaign and the number of impressions for that advertising campaign to generate a performance metric for the advertising campaign. The generated performance metric may thus indicate the percentage of impressions of the advertising campaign that resulted in a sale.

At a block 712, the system calculates the uplift of an advertisement campaign with respect to other advertisement campaigns of the business. The calculation of the block 712 may be performed on an advertisement campaign specified by the business, or it may be performed on all of the advertisement campaigns identified from the business sales data. To calculate uplift, the system evaluates the performance metric for the selected advertisement campaign against the performance metrics of other advertising campaigns of the business. By comparing the performance metrics of different advertising campaigns of a business based on sales within the same geographical region, the business is able to determine the relative effectiveness of different advertising campaigns. This enables the business to more efficiently allocate resources to different advertising campaigns.

### Alternate Embodiments

Though primarily described with reference to user identifiers received in association with advertising impressions, user identifiers may be utilized by the system that are associated with other types of exposures to a business. For example, the system may receive a user identifier when the user visits the landing page or other web page associated with a business. Such user identifier could be transmitted to the system even if no advertisement or business phone number was displayed on the web page. As a further example, the system may receive a user identifier when a user activates a communication link to a business, such as a click-to-call hyperlink located on a business web page. In some embodiments, the system may receive information characterizing the type of exposure associated with the received user identifier which may be used in generating confidence levels. For example, if a user activates a click-to-call link, which triggers a telephone call to the business from the user's telephone number, then the system may assign a greater confidence level to the correlation between the user identifier associated with the click-to-call exposure and the subsequent callee telephone number.

In some embodiments, the correlation system 102 may receive information from publishers or businesses that allow multiple phone numbers to be associated with a user identifier. For example, a user may have a mobile phone, a work phone, and a home phone. In this case, the system 102 merely associates each phone number with the same user identifier. In this fashion, a business is able to target a consumer by providing any phone number associated with the consumer to the system.

In some aspects, the system 102 will store information regarding how the user responds to a re-targeting message in order to track how effective re-targeting is for either that person individually, or collectively how effective the campaign is overall. This information may be used to refine parameters of the re-targeting campaign to improve its effectiveness.

Those skilled in the art will appreciate that the depicted flow charts may be altered in a variety of ways. For example, the order of the steps may be rearranged, steps may be performed in parallel, steps may be omitted, or other steps may be included. Those skilled in the art will further appreciate that the actual implementation of the database may take a variety of forms, and the term “database” is used herein in the generic sense to refer to any area that allows data to be stored in a structured and accessible fashion using such applications or constructs as databases, tables, linked lists, flat files, arrays, and so on.

It will be appreciated that the system 102 (and environment 100) include multiple elements coupled to one another and each element is illustrated as being individual and distinct. However in some embodiments some or all of the components and functions represented by each of the elements can be combined in any convenient and/or known manner or divided over multiple components and/or processing units. Furthermore the functions represented by the components can be implemented individually or in any combination thereof, in hardware, software, or a combination of hardware and software. Different and additional hardware modules and/or software agents may therefore be included in the environment 100 and/or system 102 without deviating from the scope of the disclosure.

I/We claim:

1. A method in a computing system for generating a dataset of source-agnostic correlations between user identifiers and telephone numbers, the method comprising:
receiving, at a computing system, event data characterizing online events associated with users and businesses, the event data comprising, for each online event, a user identifier that tracks a user's involvement with the event, an event tracking identifier associated with the event, and a date and time of the event;
receiving, at the computing system, call data describing telephone calls made to a plurality of businesses, the call data describing, for each call, a call tracking identifier associated with the business to which the call was made, a caller telephone number, and a date and time of the call;
forming a plurality of association sets between caller telephone numbers and user identifiers by:
defining, for each telephone call described in the call data, an association set, wherein each association set corresponds to the caller telephone number from the call data, the call tracking identifier from the call data, and a time segment based on the date and time of the call;
identifying, for each association set, online events from the event data in which the event tracking identifier of the online event matches the call tracking identifier corresponding to the association set and in which the date and time of the online event occurs within the time segment corresponding to the association set; and
adding, to each association set, the user identifiers from the online events identified for that association set, wherein each user identifier is assigned a confidence level based on the time segment of the association set and the date and time of the event;
determining a correlation between a telephone number from the call data and a user identifier from the event data by:
identifying the association sets corresponding to caller telephone numbers that match the telephone number;
determining a number of occurrences of the user identifier in the identified association sets;
generating a confidence level based on the number of occurrences of the user identifier in the identified association sets and on the confidence levels assigned to the user identifier in each of the identified association sets; and
storing, in a correlation dataset, a correlation entry comprising the telephone number, the user identifier, and the generated confidence level.

2. The method of claim 1, wherein the online event occurs on websites or applications.

3. The method of claim 2, wherein the online event is triggered by a user visiting a website or application.

4. The method of claim 2, wherein the online event is triggered by a user activating a telephone call function on a website or application.

5. The method of claim 1, wherein the user identifier is associated with a computing device used by a consumer to access a publisher website or application over a data channel.

6. The method of claim 5, wherein the user identifier is a cookie or an International Mobile Station Equipment Identity (IMEI).

7. The method of claim 1, wherein the generated confidence level reflects a likelihood that a consumer associated with the user identifier is the same consumer as is associated with the telephone number.

8. The method of claim 1, wherein the user identifier occurs in at least two identified association sets, and wherein the two identified association sets correspond to different call tracking identifiers.

9. The method of claim 1, wherein the user identifier occurs in at least two identified association sets, and wherein the two identified association sets correspond to different time segments.

10. The method of claim 1, wherein the event data further comprises an event location, wherein the call data further comprises a caller location, and wherein the confidence level assigned to each user identifier added to an association set is further based on a comparison of the caller location associated with the call data corresponding to the association set with the event location associated with the event data corresponding to the user identifier.

11. The method of claim 1, further comprising:
receiving a request from a business to re-target a consumer associated with a telephone number;
retrieving from the correlation dataset a correlation entry associated with the telephone number, the correlation entry comprising a user identifier and confidence level;
determining whether the confidence level satisfies a confidence threshold; and
based on the determination, transmitting a request to a publisher to cause an advertisement to be presented to a user associated with the user identifier via a publisher website or application.

12. A non-transitory computer-readable medium containing instructions configured to cause one or more processors to perform a method for generating a dataset of source-agnostic correlations between user identifiers and telephone numbers, the method comprising:
receiving, at a computing system, event data characterizing online events associated with users and businesses, the event data comprising, for each online event, a user identifier that tracks a user's involvement with the event, an event tracking identifier associated with the event, and a date and time of the event;
receiving, at the computing system, call data describing telephone calls made to a plurality of businesses, the call data describing, for each call, a call tracking identifier associated with the business to which the call was made, a caller telephone number, and a date and time of the call;
forming a plurality of association sets between caller telephone numbers and user identifiers by:
defining, for each telephone call described in the call data, an association set, wherein each association set corresponds to the caller telephone number from the call data, the call tracking identifier from the call data, and a time segment based on the date and time of the call;
identifying, for each association set, online events from the event data in which the event tracking identifier of the online event matches the call tracking identifier corresponding to the association set and in which the date and time of the online event occurs within the time segment corresponding to the association set; and
adding, to each association set, the user identifiers from the online events identified for that association set, wherein each user identifier is assigned a confidence level based on the time segment of the association set and the date and time of the event;
determining a correlation between a telephone number from the call data and a user identifier from the event data by:
identifying the association sets corresponding to caller telephone numbers that match the telephone number;
determining a number of occurrences of the user identifier in the identified association sets;
generating a confidence level based on the number of occurrences of the user identifier in the identified association sets and on the confidence levels assigned to the user identifier in each of the identified association sets; and
storing, in a correlation dataset, a correlation entry comprising the telephone number, the user identifier, and the generated confidence level.

13. The non-transitory computer-readable medium of claim 12, wherein the online event occurs on websites or applications.

14. The non-transitory computer-readable medium of claim 13, wherein the online event is triggered by a user visiting or activating a telephone call function on a website or application.

15. The non-transitory computer-readable medium of claim 12, wherein the user identifier is associated with a computing device used by a consumer to access a publisher website or application over a data channel.

16. The non-transitory computer-readable medium of claim 15, wherein the user identifier is a cookie or an International Mobile Station Equipment Identity (IMEI).

17. The non-transitory computer-readable medium of claim 12, wherein the generated confidence level reflects a likelihood that a consumer associated with the user identifier is the same consumer as is associated with the telephone number.

18. The non-transitory computer-readable medium of claim 12, wherein the user identifier occurs in at least two identified association sets, and wherein the two identified association sets correspond to different call tracking identifiers.

19. The non-transitory computer-readable medium of claim 12, wherein the event data further comprises an event location, wherein the call data further comprises a caller location, and wherein the confidence level assigned to each user identifier added to an association set is further based on a comparison of the caller location associated with the call data corresponding to the association set with the event location associated with the event data corresponding to the user identifier.

20. The non-transitory computer-readable medium of claim 12, further comprising:
receiving a request from a business to re-target a consumer associated with a telephone number;
retrieving from the correlation dataset a correlation entry associated with the telephone number, the correlation entry comprising a user identifier and confidence level;
determining whether the confidence level satisfies a confidence threshold; and
based on the determination, transmitting a request to a publisher to cause an advertisement to be presented to a user associated with the user identifier via a publisher website or application.
